(19) United States
(12) Patent Application Publication
(10) Pub. No.: US 2026/0064983 A1
(43) Pub. Date: Mar. 5, 2026

(54) Adaptive Large Language Model Selection And Refinement For Extracting Data From Documents

(71) Applicant: Oracle International Corporation, Redwood Shores, CA (US)

(72) Inventors: Christopher S. Thompson, Austin, TX (US); Daniel John Driscoll, Scottsdale, AZ (US); Samuel Aaron Witt, Sunset Beach, CA (US)

(73) Assignee: Oracle International Corporation, Redwood Shores, CA (US)

(21) Appl. No.: 19/187,473

(22) Filed: Apr. 23, 2025

Related U.S. Application Data
(60) Provisional application No. 63/690,757, filed on Sep. 4, 2024.

(51) Int. Cl. G06F 40/40; G06F 40/279

(52) U.S. Cl. CPC G06F 40/40; G06F 40/279

(57) ABSTRACT

Techniques are described herein for adaptively selecting and deploying language models, such as large language models (LLMs), to extract data from electronic documents. User overrides of extracted data are tracked and used to compute accuracy benchmarks for multiple language models. The benchmark data may drive the selection of which language model is used to extract data in a given context. The process may select different language models for different contexts depending on which language model is most accurate for the given context. Attributes other than accuracy, such as cost and latency, may also be a factor in which language model is selected. The adaptive approach allows for ongoing improvement in data extraction through reinforcement feedback while optimizing for one or more target factors, such as model accuracy, latency, and/or cost.

### INCORPORATION BY REFERENCE; DISCLAIMER

Each of the following applications are hereby incorporated by reference: Application No. 63/690,757 filed on Sep. 4, 2024. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to using and refining artificial intelligence (AI) based language models to extract data from electronic documents.

### BACKGROUND

Automated data extraction is the process of using software technologies and algorithms to automatically collect, process, and convert data from various sources into a structured format. Automated data extraction is particularly useful in data integration workflows that include the extraction of unstructured or semi-structured data contained within electronic documents, such as scanned documents, image files, emails, and social media posts.

One approach for automating data extraction is to maintain a set of rules that define the locations within an electronic document of values that need to be extracted. Optical character recognition (OCR) may be applied to convert images to text characters and obtain the values from the specified locations. While the rules-based approach works well for applications where the shape and types of electronic documents remain static, it requires new rules to be coded or otherwise defined each time a format change modifies the location of the values required for extraction or a new document type is integrated into the system. Thus, a rules-based approach is often not feasible for applications where document structures and types frequently evolve.

Another approach for automating data extraction is to train and apply neural networks. This approach adds a layer of intelligence to the extraction process that provides more accuracy when extracting values that are not at a fixed location within a given electronic document type. However, a standard neural network is generally ill-equipped to handle significant changes in the format of documents or processing completely new document types without retraining. The process of retraining the neural network is a maintenance burden that is computationally expensive as several thousand new examples may be required to create an accurate model.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example set of operations for adaptively using large language models (LLMs) to extract data from electronic documents in accordance with some embodiments;

FIG. 2 illustrates an example system architecture for adaptive selection and integration of LLMs into data ingestions applications in accordance with some embodiments;

FIG. 3 illustrates an example dashboard interface for managing LLM-based data integration workloads in accordance with some embodiments;

FIG. 4 illustrates an example interface for managing document types that are ingested by the adaptive LLM-based data extraction process in accordance with some embodiments;

FIG. 5 illustrates an example interface for editing LLM parameters for a selected document type in accordance with some embodiments;

FIG. 6 illustrates an example interface for managing LLM providers that are candidates for automated selection by the data extraction process in accordance with some embodiments;

FIG. 7 illustrates an example interface for editing LLM-specific parameters in accordance with some embodiments;

FIG. 8 illustrates an example interface presenting metrics relating to the overall health of an LLM model in accordance with some embodiments;

FIG. 9 illustrates an example interface presenting document-specific metrics associated with an LLM model in accordance with some embodiments; and

FIG. 10 illustrates a computer system in accordance with some embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### 1. GENERAL OVERVIEW

Techniques are described herein for adaptively selecting and deploying language models, such as large language models (LLMs), to extract data from electronic documents. One or more embodiments benchmark LLM (or other language model) accuracy by monitoring user overrides of extracted data. Accuracy may be benchmarked across one or more dimensions based on the number and frequency of overrides associated with the dimension(s). The benchmark data may drive the selection of which LLM model is used to extract data in a given context. The process may select different LLM models for different contexts depending on which LLM is most accurate for the given context. For example, a data extraction process may select the LLM model with the highest accuracy (lowest frequency of user overrides) for a given document type, image quality, and/or other dimension. Attributes other than accuracy, such as cost or latency, may also be a factor in which LLM is selected. The adaptive approach allows for ongoing improvement in data extraction through reinforcement feedback while optimizing for one or more target factors, such as model accuracy, average latency, and cost.

One or more embodiments continuously monitor benchmarks for changes in LLM model accuracy. Data extraction accuracy may change over time due to updates to the LLM used to extract data and/or the documents from which data is extracted. Such updates may lead to inflection points in the benchmark accuracy of one or more LLMs. If the currently selected LLM accuracy falls below a threshold, then the data extraction process may switch to another LLM model. Thus, the process may efficiently adapt to changing conditions in real-time without requiring re-coding of rules or retraining of neural networks, enhancing the efficiency of document processing within the system.

One or more embodiments refine the prompts used for each LLM to improve the accuracy of frequently misinterpreted fields. Changes to the text of an LLM prompt may elicit different responses from the LLM, which may yield improved accuracy. For example, a change from “extract the last name from this document” to “extract the surname from this document” may yield different extracted values depending on the document being processed and the LLM that is used. The system may rewrite and refine prompts if the accuracy of the LLM falls below a threshold. The system may determine and select the prompt yielding the most accurate extraction results based on the override feedback that is received and processed.

One or more embodiments provide artificial intelligence (AI) generated insights for data integration workloads. To generate insights, a prompt may be formed using one or more document processing metrics associated with the data extraction process and a set of instructions or guidelines that direct the output of the LLM. The insights may be extracted from the LLM output and presented to an end user. The AI-generated insights may be useful to help track and manage document processing backlogs, including identifying the root cause for any processing delays.

One or more embodiments described in this Specification and/or recited in the claims may not be included in this General Overview section.

### 2. ADAPTIVE DATA EXTRACTION PROCESS USING LARGE LANGUAGE MODELS

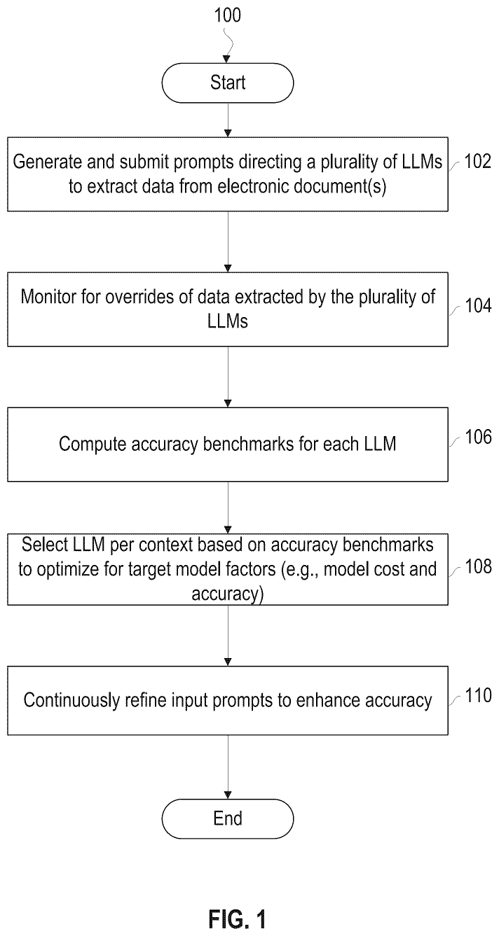

FIG. 1 illustrates an example set of operations 100 for adaptively using large language models (LLMs) to extract data from electronic documents in accordance with some embodiments. One or more operations illustrated in FIG. 1 may be modified, rearranged, or omitted all together. Accordingly, the particular sequence of operations illustrated in FIG. 1 should not be construed as limiting the scope of one or more embodiments.

The process includes generating and submitting prompts that direct a plurality of LLMs to extract data from one or more electronic documents (operation 102). For example, the plurality of LLMs may extract attribute values such as key-value pairs, fields, and/or other table data from an image file and/or other file type. In some embodiments, the same prompt and electronic document may be submitted to different LLMs, which allows a direct comparison of results. However, in other embodiments, the prompts and/or electronic documents may vary from one LLM request to the next.

The format of the electronic documents that are submitted for processing may vary from implementation to implementation. Example electronic documents may include scanned documents, image files, emails, social media posts, word processing documents, web documents, portable document format documents, or any other file format that is ingestible by an LLM. Documents may be classified by document type corresponding to a particular category or kind of document serving a particular purpose. Different document types may have different structures and unique information, which are designed to serve different purposes. Example document types include driver's licenses, passports, birth certificates, social security cards, visas, report cards, transcripts, medical history records, patient intake forms, laboratory repots, etc. Each document type contains specific information relevant to its function that may be useful to a data ingestion workload. For example, many software resources and technologies may benefit from the automated extraction of student data from transcripts and/or other documents. As another example, a variety of technologies in the health sector may benefit from automated extraction and ingestion of patient data.

The process includes monitoring for overrides of the data extracted by the plurality of LLMs (operation 104). Users may review all or a sample of the data extracted by an LLM. A n override occurs when the user corrects a value that was automatically populated by the LLM for a corresponding field, key, or other attribute. User corrections may be submitted through a user interface. For example, the process may generate an interactive page that is presented to the user through a graphical user interface (GUI). The GUI may include GUI elements that allow the user to approve or edit AI-extracted values from a document.

The process includes computing accuracy benchmarks for each LLM (operation 106). An accuracy percentage benchmark may be computed based on the number of overrides versus the number of samples reviewed or the total number of documents processed by the LLM. The percentage metric may treat any override for a given document as a complete failure or may be computed based on what percentage of fields extracted from the document were overridden. Additionally or alternatively, a rolling window or time-weighted values may be applied to give more weight to more recent data. This allows for model updates that change the accuracy of the model to be more quickly captured in the benchmark metrics and applied to the document extraction process.

In some embodiments, accuracy benchmark metrics are computed across one or more dimensions. The dimensions may be used to group document extraction tasks to determine areas in which an LLM excels and areas where the LLM is suboptimal. A n example dimension is document type. Accuracy metrics may be computed separately and monitored for each document type. For example, the LLM's accuracy with extracting key-value pairs from a driver's license may differ from its accuracy for passports and/or other types of documents. The process may compute separate accuracy percentages/scores based on the number or frequency of overrides for the given document type. Other example dimensions include image quality and image type. Some LLMs may have higher accuracy when extracting data from images of a certain quality of resolution and/or image type (e.g., png vs. jpeg) than other LLMs. The accuracy metrics may capture which LLMs are optimal at extracting data for a given dimension (or combination of dimensions).

The process includes selecting an LLM for a given context based on the benchmark metrics (operation 108). In some embodiments, this operation includes selecting an LLM per document type to optimize for accuracy, responsiveness, and/or cost-efficiency. Depending on the particular implementation, a higher-cost and/or higher-latency LLM may not be warranted unless significantly more accurate than a lower-cost and/or lower-latency LLM. For example, if the higher cost LLM is only one percent more accurate than a lower-cost LLM, then the process may select the lower-cost LLM. On the other hand, if the difference in LLM accuracy is greater than a threshold (e.g., 10%), then the process may select the higher cost LLM. As another example, if the average latency of an LLM exceeds a threshold, then a lower latency model may be selected to optimize for responsiveness if the accuracy is within a threshold range. The threshold cost, latency, and accuracy metrics may vary depending on the particular implementation and may be configurable by an end user.

The selection of LLMs may happen dynamically and adaptively as conditions change. For example, the process may start with a default LLM to extract data for a given document type. If the accuracy of the LLM falls below a threshold, then the process may select a different LLM. The process may iterate, gathering more performance data for each of the LLMs and changing LLM models to optimize for one or more of the parameters described above, thereby improving data extraction accuracy through reinforcement feedback.

The real-time adaptive selection process may occur independently per dimension (or combination of dimensions). For example, the selection process for one document type (e.g., passports) may execute independently from the selection of another document type (e.g., driver's license). Thus, the process may identify and select the LLMs that excel at specific document types (or other given contexts, depending on the dimensions).

In some embodiments, the selection process selects more than one LLM to process documents for a given context. Data may be extracted from documents through a multi-LLM collaboration. For example, the system may route the same document to multiple LLMs, then use an LLM to compare or vote on the results. A multi-LLM approach may add fault tolerance and improve accuracy through consensus, reducing the need for manual review. The selection process may evaluate the use of different combinations of models in addition or as an alternative to the use of individual models, optimizing for accuracy, cost, and/or latency. The selection process may evaluate other factors, such as giving different LLM results different weights in voting or influence on the final extracted result.

The ensemble of LLMs that are selected may vary from one context to the next. For example, one ensemble of LLMs may be more accurate at extracting data for a given document type while a different ensemble (or individual LLM) is selected for a different document type. Additionally or alternatively, the roles of the LLMs that are selected may vary from one context to the next. For instance, one LLM may be used to compare results or votes of an ensemble of LLMs in one context, while a different LLM may be selected for this role in a different context to optimize for the target factors.

The process further includes continuously refining the prompts used for each LLM to optimize for accuracy of frequently misinterpreted fields (operation 110). In some embodiments, refining the prompts is performed using an LLM. For example, a prompt may be generated that requests that the LLM reword or rephrase the prompt based on which fields are misinterpreted frequently. The LLM's output may serve as the new prompt for future data extractions (using the same LLM or a different LLM). The new prompt extraction accuracy metrics may be compared to the previous prompts extraction accuracy metrics. If the new prompt yields worse results (i.e., lower accuracy), then the process may revert to the previous prompt. Otherwise, the current prompt may be maintained and refined. It is noted that the fields that are misinterpreted most frequently may vary from one LLM to the next. Thus, the refinement paths for a given prompt may follow different paths per LLM, and the end result may be significantly different prompts for different LLMs that yield the best results for that LLM.

Additionally or alternatively, a refined prompt may be created based on user input. The process may highlight the fields that are misinterpreted most frequently to the end user, which may help guide the user in reformulating the input prompt. The user may rewrite or otherwise edit the input prompt through a user interface, examples of which are provided below.

### 3. SYSTEM ARCHITECTURE AND COMPONENTS

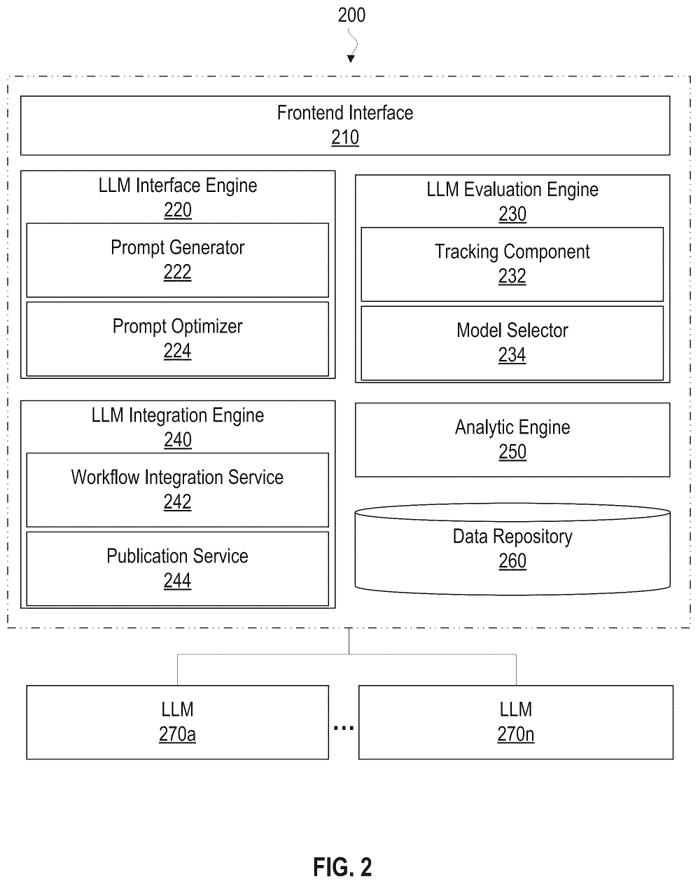

FIG. 2 illustrates an example system architecture for adaptive selection and integration of LLMs into data ingestions applications in accordance with some embodiments. As illustrated in FIG. 2, the system 200 includes frontend interface 210, LLM interface engine 220, LLM evaluation engine 230, LLM integration engine 240, analytic engine 250, and data repository 260. In one or more embodiments, system 200 may include more or fewer components than the components illustrated in FIG. 2. The components illustrated in FIG. 2 may be local to or remote from each other. The components illustrated in FIG. 2 may be implemented in software and/or hardware. Each component may be distributed over multiple applications and/or machines. Multiple components may be combined into one application and/or machine. Operations described with respect to one component may instead be performed by another component.

Frontend interface 210 allows users to review and manage document ingestions tasks. For example, the interface may allow the user to define the parameters for a data ingestion task, such as the source of the electronic documents to ingest, the key-value pairs (or other attribute values) to extract from the documents, the destination where extracted values are stored, the LLMs to use/evaluate during the extraction process, and authentication data (passwords, authentication credentials, certificates, etc.) for accessing the LLMs.

In some embodiments, frontend interface 210 refers to hardware and/or software configured to facilitate communications between a user and the system. Examples of interfaces include a GUI, a command line interface (CLLI), a haptic interface, and a voice command interface. Examples of user interface elements include checkboxes, radio buttons, dropdown lists, list boxes, buttons, toggles, text fields, date and time selectors, command lines, sliders, pages, and forms.

LLM interface engine 220 allows applications to connect and interact with LLMs 270a-n. LLM interface engine 220 may interact with LLMs through application programming interface (API) or through a library integration. With API integration, input prompts and/or other requests are sent to a remote server that hosts the LLM. LLM interface engine 220 may maintain data used to generate API calls for different LLM s. Example components may include an API endpoint, such as the uniform resource locator (U R L) or other address of the LLM service that is being called, an API key for authenticating the API calls, and headers including metadata used by the LLM to process the request. With library integration, the LLM may run locally on a host device using a library, and requests may be made directly through code without making HTTP calls.

In some embodiments, LLM interface engine 220 includes prompt generator 222 and prompt optimizer 224. Prompt generator 222 generates a set of input prompts that direct LLM s 270a-n to perform tasks. For example, prompt generator 222 may generate data extraction prompts that include a request for the LLMs to extract key-value pairs and/or other attribute values from one or more electronic documents. As another example, prompt generator 222 may generate an analytic prompt that directs an LLM to provide insights into a data ingestion process. LLM interface engine 220 may build an API call that includes the input prompt and/or provide the prompt directly to an LLM through if integrated through an installed library.

In some embodiments, an LLM input prompt includes text that prompt the LLM to provide a response. The text may vary from one input prompt to another depending on one or more factors such as the extraction task, the document type, the LLM receiving the prompt, and/or accuracy metrics. For example, prompt generator 222 may generate a prompt including the text “extract the last name from this document” if more accurate in one context (e.g., for a particular LLM and/or document type) and “extract the surname from this document” for another context (e.g., a different LLM and/or document type). In other cases, the same text may be used across multiple input prompts.

Prompt optimizer 224 generates modified versions of input prompts to improve data extraction accuracy. In some embodiments, prompt optimizer 224 analyzes corrections to AI-extracted attribute values to identify commonalities. If prompt optimizer 224 identifies a field that has been corrected more than a threshold number of times or at more than a threshold frequency, then prompt optimizer 224 may refine a prompt from which the incorrect extraction resulted.

In some embodiments, prompt optimizer 224 uses an LLM to refine an input prompt. Prompt optimizer 224 may generate a new input prompt that requests that the LLM reword the text of the input prompt that is the target of refinement. The new input prompt may further include contextual information for the refinement, such as identifying a field or attribute for which corrections are frequently made. For example, prompt optimizer 224 may submit an input prompt requesting that the text “extract the last name from this document” be refined for a particular document type as it results in an LLM frequently extracting the wrong value for the last name attribute. Prompt optimizer 224 may iteratively update the prompt until a threshold extraction accuracy rate has been achieved.

LLMs 270a-n refer to a type of artificial intelligence trained to understand and process unstructured natural language text. A n LLM varies from a regular (non-large) language model in scale with respect to training and the model architecture. LLMs are typically trained on massive datasets with billions or more parameters. LLMs may be implemented using transformer architectures that process entire sequences in parallel using self-attention, whereas regular language models generally process data sequentially and have fewer neural network layers in the underlying model architecture. LLMs have broad knowledge across a variety of domains that are more versatile and robust than smaller language models. However, regular language models do not require as many resources and may run on smaller devices while being fine-tuned to perform domain-specific tasks. Embodiments herein use LLMs in example embodiments as the LLMs are more versatile in extracting data from electronic documents. However, the techniques may also be applied to regular (non-large) language models and/or other types of machine learning models.

LLM evaluation engine 230 includes accuracy tracking component 232 and model selector 234. Tracking component 234 tracks extraction accuracy across one or more dimensions. For example, tracking component may track the accuracy of each LLM for each document type, as previously described. Tracking component 234 may compute the accuracy as a function of the number of overrides versus uncorrected values for the given context. Time weighting may be applied to bias more recent corrections and “forget” corrections that are older. Time weighting allows for improvements in model performance (e.g., due to fine-tuning, prompt updates, etc.) to be more quickly accounted for by system 200.

Model selector 234 selects which LLM to use for data ingestion tasks. In some embodiments, model selector 234 determines a context associated with a data ingestion task. To determine the context, model selector 234 may determine a set of values associated with the context for the data ingestion task. For example, model selector 234 may determine a document type that is being ingested based on metadata tagged to the document. In other cases, model selector 234 may query an LLM or classification model to determine the document type. As another example, model selector 234 may determine one more image quality attributes associated with a document being ingested. Model selector 234 may analyze the image and/or image metadata to determine the resolution, sharpness, noise, compression artifacts, contrast/brightness, and/or other image attributes.

Once the dimensional values are determined, then model selector 234 selects one or more of LLMs 270a-n to ingest the document (or set of documents). One approach is to select the LLM or an ensemble of LLMs that has the highest accuracy metrics for the given context. For example, model selector 234 may select an LLM or subset of LLMs that has the highest accuracy extracting values from a particular type of document or documents with a particular image quality (resolution, sharpness, noise, etc.). However, as previously mentioned, other target factors, such as model cost and latency, may also be factored into the selection.

In other embodiments, model selector 234 may be implemented using an LLM. For instance, the selection process may include generating an input prompt that requests that the LLM select an LLM to extract data a given context. The prompt may include the dimensional attributes, accuracy metrics, and/or other supplemental information to guide the LLM's selection. In response to receiving the prompt, the LLM may select the same LLM or a different LLM to extract data from a target set of one or more electronic documents.

When switching from one LLM (or ensemble of LLMs) to another, such as when the accuracy of an LLM falls below a threshold, model selector 234 may automatically perform a switchover or present a recommended model change to an end user for review. In the former scenario, the switchover may be executed transparently to the end user without any manual input. In the latter, the system may continue using the previous model until the switchover is explicitly approved by the user. If not approved, then model selector 234 may make alternate recommendations based on which LLM has the highest accuracy score or otherwise are predicted to optimize the target factors.

LLM integration engine 240 coordinates the integration of selected LLMs with the execution of document ingestion tasks. LLM integration 240 includes workflow integration service 242 and publication service 244. Workflow integration service 242 plugs the selected LLMs for a given context into a process to automate data extraction. For example, workflow integration service 242 may coordinate with LLM interface engine 220 to make API calls to the selected LLM (or ensemble of LLM s) at the appropriate time. In response, LLM interface engine 220 may construct an API call to the selected LLM. As previously noted, the API call may include an input prompt with text, which may have been refined for the given context and/or LLM, directing the LLM to extract data for a set of one or more electronic documents.

In some embodiments, workflow integration service 242 further manages processing of LLM outputs. For example, some LLMs may output a JavaScript Object Notation (J SON) file that includes extracted key-value pairs. However, the output format may vary from one LLM to another. Workflow integration service 242 may configure an application to parse the output of an LLM and store the extracted values within a database or other data store, such as data repository 270.

In scenarios where an ensemble of LLMs are selected, workflow integration service 242 may route the outputs through another LLM to compare and make a final decision on the extracted value. A new input prompt may be formulated as a function of the outputs of the selected ensemble of LLMs that directs a managing LLM to compare the results and output a final value for a key-value pair. In other embodiments, the final value may be selected programmatically or using other types of machine learning models. For example, a rule-based approach may select the value that the majority of LLMs have output. As another example, outputs of different LLMs may be weighted differently for a given context based on historical accuracy metrics.

Publication service 244 may publish selected LLMs to applications that perform document ingestion. For example, an enterprise system may include a suite of applications that are configured to perform document ingestion tasks. As another example, a cloud service may include a set of applications distributed over several different servers, which may be in distinct geographic locations. When a selection has been made or modified, publication service 244 may send notifications that identify which LLM to use for a given context. In response to receiving the notifications, the receiving client/application may update its client/application data to direct future ingestion tasks to the selected LLM for the given context.

Analytic engine 250 tracks and provides insights into current and/or historical data extraction tasks. In some embodiments, analytic engine 250 tracks a set of metrics associated with a data ingestion process. Example metrics may include total documents processed, number of documents in a backlog waiting to be ingested, total time to process a batch of documents, average time/latency to process an individual document, number of documents waiting for review, average age of a document awaiting review, timestamps of when an electronic document is added to be processed, and timestamps of when the electronic document ingestion was completed. Additionally or alternatively, analytic engine 250 may track performance metrics associated with individual LLMs, such as how many documents have been processed by each individual LLM, accuracy rate across one or more dimensions, cost metrics, latency metrics (e.g., average model response times), etc.

In some embodiments, analytic engine 250 interacts with an LLM to provide AI-generated insights about a document ingestion task. For instance, analytic engine 250 may generate an input prompt that directs an LLM to summarize trends, identify delays, isolate root causes, and/or otherwise provide analytics based on one or more of the tracked metrics. As an example, an input prompt may request that the LLM to summarize and provide insights on to how to more efficiently process documents during peak workloads and/or with respect to a current backlog. In response, the LLM may output a natural language description that provides insights into current workload trends, including the root causes of any backlog/delays and suggestions on how to address the issue. The analysis may be presented via frontend interface 210 and/or used to trigger automated actions within system 100 to address the backlog. Example actions may include updating input prompts used to extract values, changing what LLMs are used, and deploying additional resources during peak workload hours. However, the actions may vary depending on the insights and particular implementation.

Data repository 260 stores data associated with the adaptive selection and integration of LLMs into data extraction workflows. For example, data repository 260 may store evaluation metrics, selection data, API endpoint/parameter data, analytic data, AI-generated insights, etc.

In some embodiments, data repository 260 is any type of storage unit and/or device (e.g., a file system, database, collection of tables, or any other storage mechanism) for storing data. Further, data repository 260 may include multiple different storage units and/or devices. The multiple different storage units and/or devices may or may not be of the same type or located at the same physical site. Further, data repository 260 may be implemented or executed on the same computing system as system 200. Additionally, or alternatively, data repository 260 may be implemented or executed on a computing system separate from system 200. Data repository 260 may be communicatively coupled to system 200 via a direct connection or via a network.

### 4. EXAMPLE EMBODIMENTS AND USER INTERFACES

In some embodiments, users may view and manage the document extraction process through one or more user interface pages. The user interface may allow a user to provide reinforcement feedback by reviewing and overriding extracted values, refining input prompts, specifying document types, and linking LLM models to evaluate. The user interface may provide A l-generated insights into the document extraction process and associated document integration workloads.

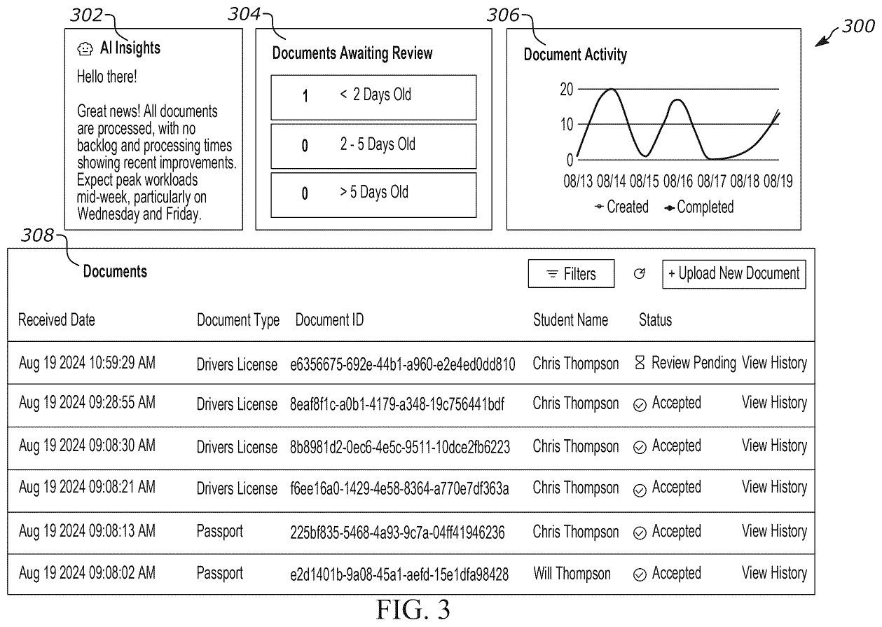

FIG. 3 illustrates an example dashboard interface for managing LLM-based data integration workloads in accordance with some embodiments. Dashboard 300 includes AI-generated insights 302 that give an overview of how many documents are processed, what the current backlog is, what performance trends have been recently observed, and when the peak workload hours occur. Dashboard 300 further provides metrics 304 on how many documents are awaiting review and a graph 306 of document activity over the past week. Document section 308 allows the users to select and review individual documents as well as upload new documents for processing.

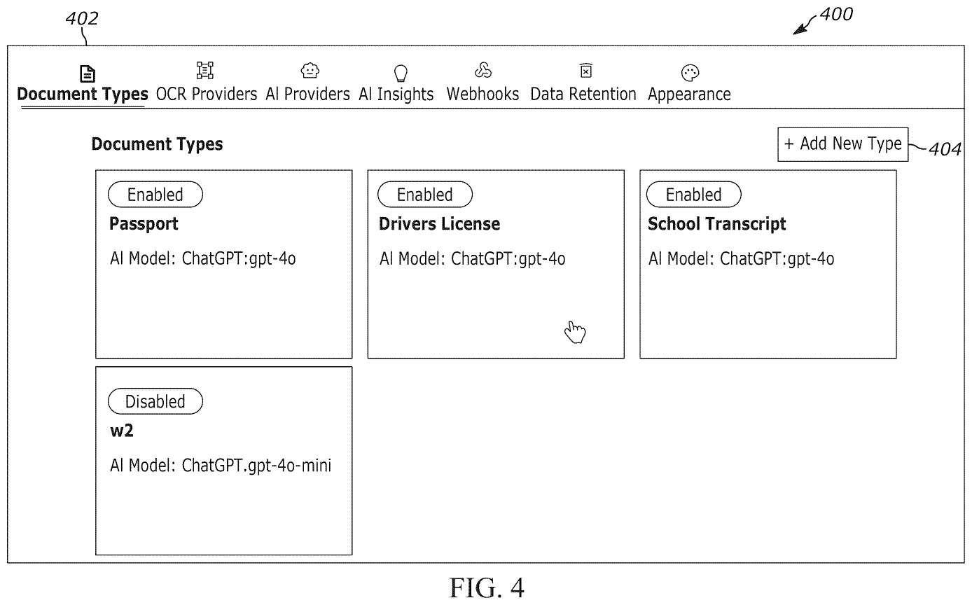

FIG. 4 illustrates an example interface 400 for managing document types that are ingested by the adaptive LLM-based data extraction process in accordance with some embodiments. Interface 400 identifies document types 402 that the system is configured to ingest. In the illustrated example, the document types include passport, driver's license, school transcripts, and w2 tax forms. Interface 400 allows the user to add new document types by clicking on or otherwise selecting button 404. Interface 400 further allows the user delete existing document types. The user may select a source from which to extract documents of the specified type. The system may pull documents for processing from the specified source either continuously, periodically, or on demand. Additionally or alternatively, users may push/upload documents to the system for processing.

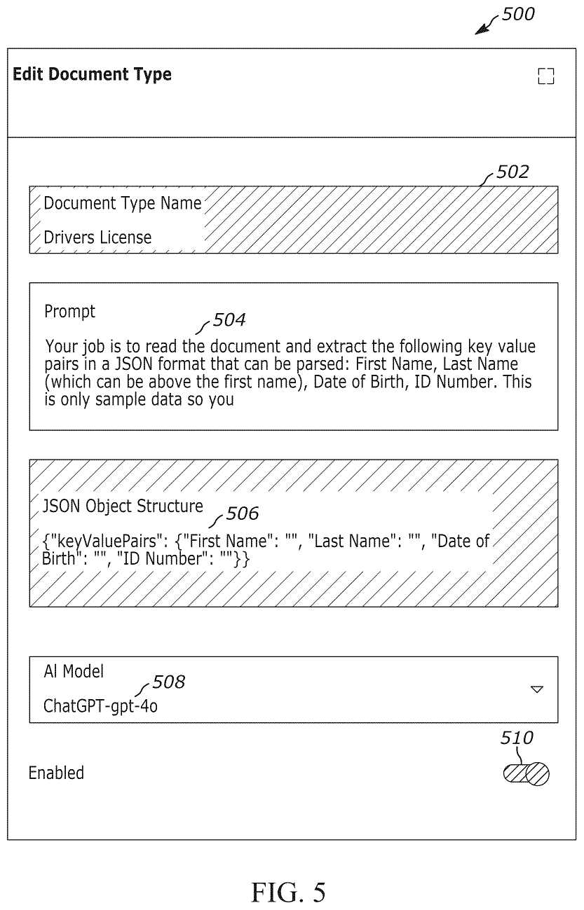

FIG. 5 illustrates an example interface 500 for editing LLM parameters for a selected document type in accordance with some embodiments. Interface 500 includes data entry field 502, which allows a user to specify a name of a document type. In the illustrated example, the user is editing parameters associated with a Driver's License document type. Field 504 allows the user to review and edit input prompts to an LLM. The input prompt specifies instructions on the key-values to extract, the task assigned to the LLM, and the output format for the response. Field 506 allows a user to specify a structured output format for the LLM to use when generating the output. Selector 508 allows the user to select a specific LLM. The parameters may be customized and applicable to a specific LLM or may be applied across multiple LLMs. Interface 500 further includes slider 510, which allows the user to enable or disable automated data extraction for the corresponding document type.

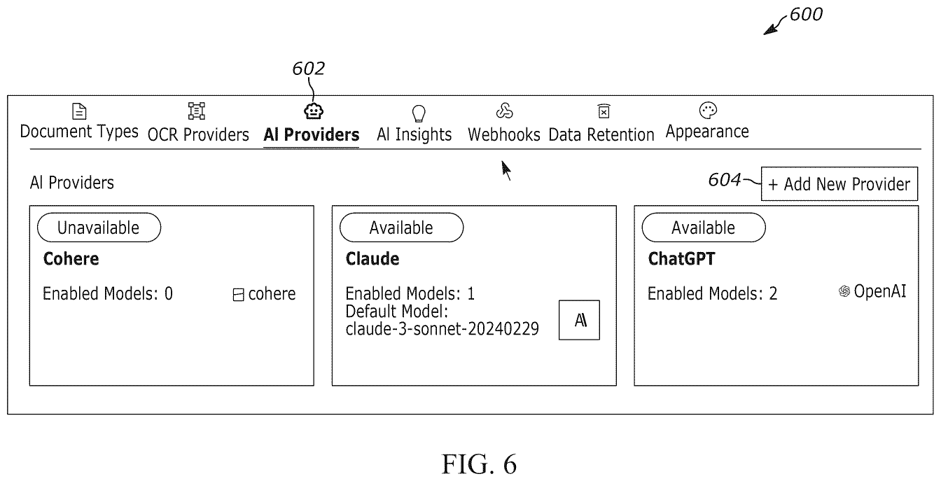

FIG. 6 illustrates an example dashboard 600 for managing LLM providers that are candidates for automated selection by the data extraction process in accordance with some embodiments. A l-provider section 602 allows the users to select and review AI service providers to use for data ingestion workloads. Dashboard 600 includes button 604, which when clicked or otherwise selected, presents an interface through which a user may add new providers. Dashboard 600 further allows users to remove existing providers. The listed providers act as a candidate set for evaluation and selection by the data extraction process. The illustrated example depicts Cohere, Claude, and ChatGPT. The process may compute benchmarks and select a model per document type to optimized for accuracy, latency, and/or cost.

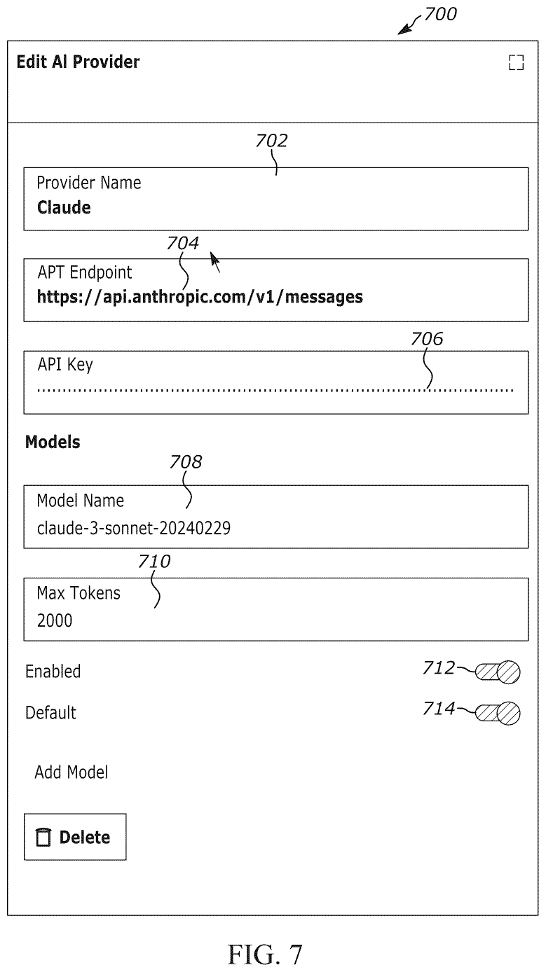

FIG. 7 illustrates an example interface 700 for editing LLM-specific parameters in accordance with some embodiments. Interface 500 includes data entry field 702, which allows a user to specify a name of an AI provider. Field 704 allows the user to review and update an API endpoint associated with the AI provider. Field 706 allows the user to review and edit an API key. As previously mentioned, the API endpoint and key may be used to create API calls to access an LLM. Field 708 allows a user to review and edit the model name, and field 710 allows the user to specify a max token count. The maximum number of tokens restricts the input prompts to a maximum size. The prompt refinement process may account for the maximum size when modifying a prompt such that any changes to not exceed the specified limit. Slider 712 and slider 714 allow the user to enable the model and/or set the model as the default to use. If set to default, the process may use the model until the benchmark accuracy falls below a threshold, at which point another model may be selected and evaluated.

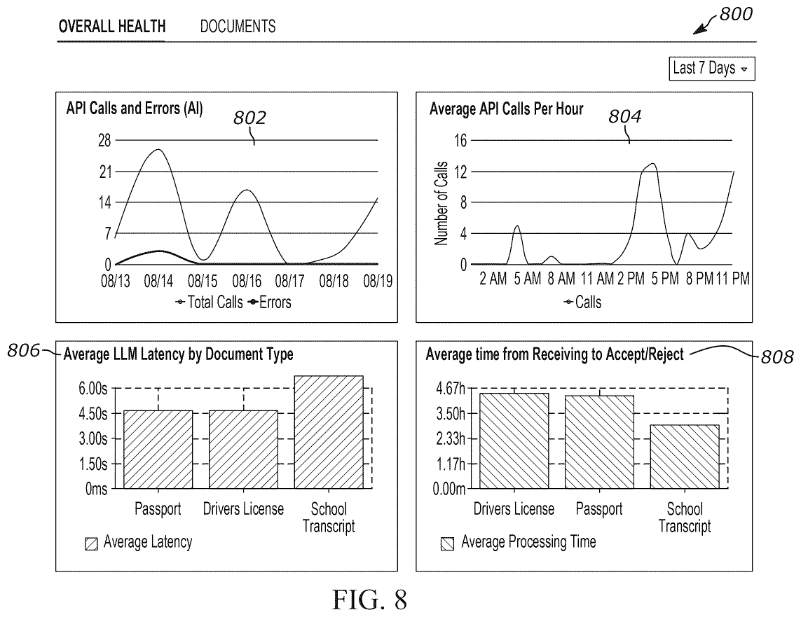

FIG. 8 illustrates an example interface 800 presenting metrics relating to the overall health of an LLM model in accordance with some embodiments. In the illustrated example, the metrics show API calls and errors (chart 802), average API calls per hour (chart 804), average LLM latency by document type (chart 806), and average time from receiving results to review for different document types (chart 808). The charts incorporate date from the past seven days in the illustrated example, although the user may change the timeframe for the analysis.

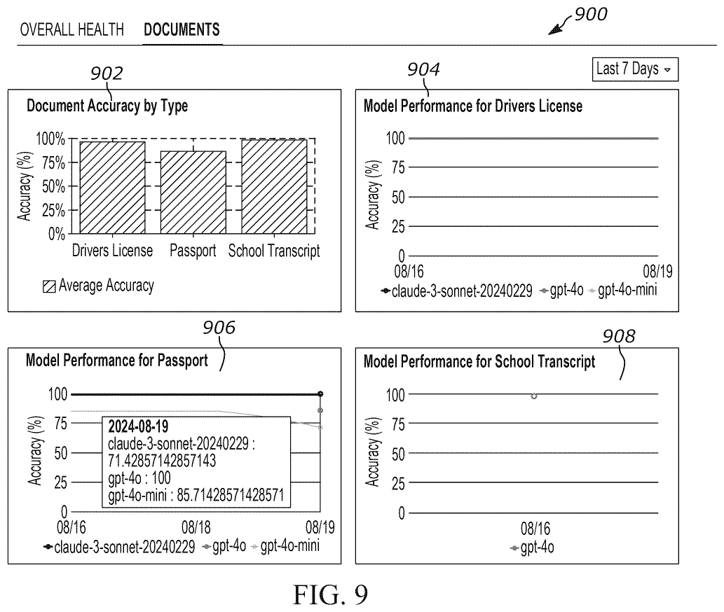

FIG. 9 illustrates an example interface 900 presenting document-specific metrics associated with an LLM model in accordance with some embodiments. The metrics show the accuracy of the LLM model with respect to different document types (chart 902) and allow the user to view historical accuracy trends by document type. In the illustrated example, interface 900 presents the model performance for driver license documents (chart 904), passport documents (chart 906), and school transcripts (chart 908). The diagrams may be used to visualize inflection points where model accuracy suddenly changed (improved or worsened) for different document extraction tasks.

As previously noted, AI-generated insights may be generated by an LLM by formulating a prompt. The prompt may include a set of metrics within a given window of time, including any of the LLM and document processing metrics described above and/or illustrated in the figures. The insights may then be presented to an end user, such as within dashboard interface 300 as depicted in FIG. 3. The A l-generated insights may help mitigate and isolate the root cause for any processing delays, including identifying how different LLMs, document types, and timeframes impact workload. Generally, the fewer data extraction errors the user corrects within a given timeframe, the faster documents can be processed and ingested by the system.

The extracted data may be integrated for consumption by one or more downstream applications. For example, the data may be added to a database that is accessible to one or more enterprise applications. The enterprise applications may use the data for a variety of tasks, such as training machine learning models or executing custom application logic.

### 5. COMPUTER NETWORKS AND CLOUD NETWORKS

In some embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. A n overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). A n overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In some embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In some embodiments, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In some embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In some embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. A n interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In some embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In some embodiments, in a multi-tenant computer network, tenant isolation is implemented to ensure that the applications and/or data of different tenants are not shared with each other. Various tenant isolation approaches may be used.

In some embodiments, each tenant is associated with a tenant ID. Each network resource of the multi-tenant computer network is tagged with a tenant ID. A tenant is permitted access to a particular network resource only if the tenant and the particular network resources are associated with a same tenant ID.

In some embodiments, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In some embodiments, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In some embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

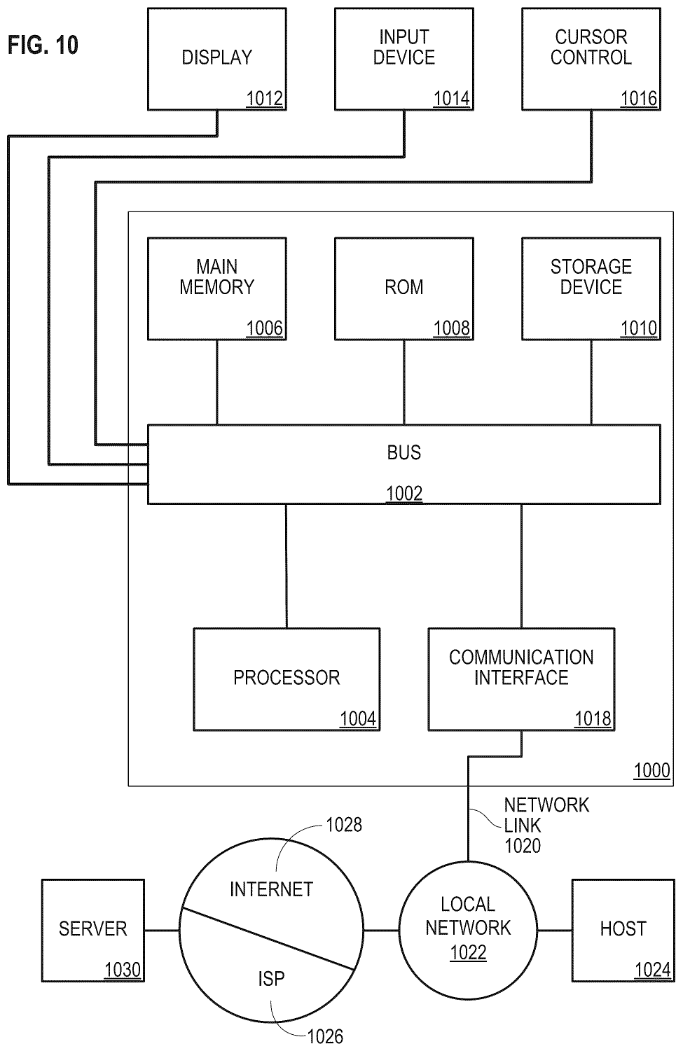

For example, FIG. 10 is a block diagram that illustrates computer system 1000 upon which some embodiments of the invention may be implemented. Computer system 1000 includes bus 1002 and/or one or more other communication mechanisms for transferring data between system components. Computer system 1000 also includes hardware processor 1004 coupled with bus 1002 for processing information. Hardware processor 1004 may be, for example, a general-purpose microprocessor.

Computer system 1000 further includes main memory 1006, such as random-access memory (RAM) and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 and/or other static storage device coupled to bus 1002 for storing static information and instructions for processor 1004. Storage device 1010, such as a magnetic disk or optical disk, is provided and coupled to bus 1002 for storing information and instructions.

Computer system 1000 may be coupled via bus 1002 to display 1012, such as a cathode ray tube (CRT) or light-emitting diode (LED) screen, for displaying information to a computer user. Input device 1014, including alphanumeric and other keys, is coupled to bus 1002 for communicating information and command selections to processor 1004. Another type of user input device is cursor control 1016, such as a touchscreen, mouse, a trackball, or cursor direction keys for communicating direction information and command selections to processor 1004 and for controlling cursor movement on display 1012. This input device may have two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. A n infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes communication interface 1018 coupled to bus 1002. Communication interface 1018 provides a two-way data communication coupling to network link 1020 that is connected to local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LA N) card to provide a data communication connection to a compatible LA N. W ireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to host computer 1024 or to data equipment operated by Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### 7. MISCELLANEOUS; EXTENSIONS

Embodiments are directed to a system with one or more devices that include a hardware processor and that are configured to perform any of the operations described herein and/or recited in any of the claims below.

In some embodiments, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
generating a set of input prompts for a plurality of language models that direct the plurality of language models to extract attribute values from a plurality of electronic documents;
tracking corrections to the attribute values extracted by the plurality of language models;
determining, in association with a particular context, an accuracy benchmark for each language model of the plurality of language models based at least in part on the corrections to the attribute values; and
selecting, for the particular context, at least one language model from the plurality of language models based at least in part on the accuracy benchmark for each language model of the plurality of language models.

2. The method of claim 1, wherein the particular context is defined by a set of one or more dimensions associated with the plurality of electronic documents; the method further comprising: selecting different language models for different contexts.

3. The method of claim 1, wherein the particular context is based at least in part on a document type; the method further comprising: selecting different language models to extract data for different document types based on which language model has a highest accuracy benchmark for a given document type.

4. The method of claim 1, wherein the particular context is based at least in part on at least one of an image quality or an image type; the method further comprising: selecting different language models to extract data for an ingested image file based on the image quality or the image type of the ingested image file.

5. The method of claim 1, further comprising: determining that the accuracy benchmark for the at least one language model that was selected has fallen below a threshold; and in response to determining that the accuracy benchmark has fallen below the threshold, selecting a different language model from the plurality of language models to perform future data extraction tasks.

6. The method of claim 1, further comprising: determining that the accuracy benchmark for the at least one language model that was selected has fallen below a threshold; and in response to determining that the accuracy benchmark has fallen below the threshold, selecting a different language model from the plurality of language models to perform future data extraction tasks.

7. The method of claim 1, wherein the at least one language model is further selected based on at least one of a cost or latency associated with accessing the at least one language model.

8. The method of claim 1, further comprising: refining the set of input prompts based on corrections to the attribute values; wherein refining the set of input prompts includes: generating a second set of one or more input prompts that direct a second set of one or more language models to modify at least one of the set of input prompts.

9. The method of claim 1, further comprising: generating a second set of one or more input prompts that direct a second set of one or more language models to generate an analysis of a document ingestion task; and generating an interface based on the analysis output by the second set of one or more language models.

10. The method of claim 1, further comprising: receiving a new set of electronic documents from which to ingest data; responsive to receiving a new set of electronic documents, using the at least one language model to extract a set of key-value pairs from the set of electronic documents; and storing the key-value pairs within at least one data store.

11. One or more non-transitory computer readable media storing instructions that, when executed by one or more hardware processors, cause performance of a set of operations comprising:
generating a set of input prompts for a plurality of language models that direct the plurality of language models to extract attribute values from a plurality of electronic documents;
tracking corrections to the attribute values extracted by the plurality of language models;
determining, in association with a particular context, an accuracy benchmark for each language model of the plurality of language models based at least in part on the corrections to the attribute values; and
selecting, for the particular context, at least one language model from the plurality of language models based at least in part on the accuracy benchmark for each language model of the plurality of language models.

12. The media of claim 11, wherein the particular context is defined by a set of one or more dimensions associated with the plurality of electronic documents; the operations further comprising: selecting different language models for different contexts.

13. The media of claim 11, wherein the particular context is based at least in part on a document type; the operations further comprising: selecting different language models to extract data for different document types based on which language model has a highest accuracy benchmark for a given document type.

14. The media of claim 11, wherein the particular context is based at least in part on at least one of an image quality or an image type; the operations further comprising: selecting different language models to extract data for an ingested image file based on the image quality or the image type of the ingested image file.

15. The media of claim 11, the operations further comprising: determining that the accuracy benchmark for the at least one language model that was selected has fallen below a threshold;
and in response to determining that the accuracy benchmark has fallen below the threshold, selecting a different language model from the plurality of language models to perform future data extraction tasks.

16. The media of claim 11, the operations further comprising: determining that the accuracy benchmark for the at least one language model that was selected has fallen below a threshold;
and in response to determining that the accuracy benchmark has fallen below the threshold, selecting a different language model from the plurality of language models to perform future data extraction tasks.

17. The media of claim 11, wherein the language model is further selected based on at least one of a cost or latency associated with accessing the language model.

18. The media of claim 11, the operations further comprising: refining the set of input prompts based on corrections to the attribute values; wherein refining the set of input prompts includes: generating a second set of one or more input prompts that direct a second set of one or more language models to modify at least one of the set of input prompts.

19. The media of claim 11, the operations further comprising: generating a second set of one or more input prompts that direct a second set of one or more language models to generate an analysis of a document ingestion task; and generating an interface based on the analysis output by the second set of one or more language models.

20. The media of claim 11, the operations further comprising: receiving a new set of electronic documents from which to ingest data; responsive to receiving a new set of electronic documents, using the at least one language model to extract a set of key-value pairs from the set of electronic documents; and storing the key-value pairs within at least one data store.
